(19) United States
(12) Patent Application Publication
(10) Pub. No.: US 2019/0092074 A1
(43) Pub. Date: Mar. 28, 2019

(54) APPARATUS FOR TURNING PAGES OF A BOOK AND ACCOMMODATION METHOD FOR SAME

(71) Applicant: CASIO COMPUTER CO., LTD., Tokyo (JP)

(72) Inventors: Hirokazu HASEGAWA, Tokyo (JP); Toshiaki KANAMURA, Tokyo (JP); Yasushi MURAI, Tokyo (JP)

(73) Assignee: CASIO COMPUTER CO., LTD., Tokyo (JP)

(21) Appl. No.: 16/134,022

(22) Filed: Sep. 18, 2018

(30) Foreign Application Priority Data
Sep. 26, 2017 (JP) 2017-185114
Sep. 26, 2017 (JP) 2017-185118
Sep. 26, 2017 (JP) 2017-185120
Sep. 26, 2017 (JP) 2017-185122
Sep. 26, 2017 (JP) 2017-185125
Feb. 20, 2018 (JP) 2018-027654
Feb. 20, 2018 (JP) 2018-027655

(51) Int. Cl. B42D 9/04; H04N 1/00

(52) U.S. Cl. CPC B42D 9/04; H04N 1/00567; H04N 1/00559

(57) ABSTRACT

When a page turner is to be accommodated, a holding table is folded, and an air blowing section is rotated and moved toward a side surface of an accommodation case where a page-turning mechanism can be accommodated, whereby the upper surface of the accommodation case and the air blowing port of the air blowing section are substantially flush with each other. Also, an expansion unit is removed from the holding table, and a casing is closed to cover a page-turning main body section constituted by the accommodation case and the air blowing section and the holding table. As a result, the entire page turner is accommodated in a substantially rectangular parallelepiped shape whose vertical and horizontal size is equal to a vertical and horizontal size of a predetermined book. Finally, the page turner is inserted between a pair of side plates constituting leg sections in an image pickup apparatus stand.

### CROSS-REFERENCE TO RELATED APPLICATIONS

This application is based upon and claims the benefit of priority from the prior Japanese Patent Applications No. 2017-485114, filed Sep. 26, 2017, No. 2017-185118, filed Sep. 26, 2017, No. 2017-185120, filed Sep. 26, 2017, No. 2017-185122, filed Sep. 26, 2017, No. 2017-185125, filed Sep. 26, 2017, No. 2018-027654, filed Feb. 20, 2018, and No. 2018-027655, filed Feb. 20, 2018, the entire contents of which are incorporated herein by reference.

### BACKGROUND OF THE INVENTION

### 1. Field of the Invention

The present invention relates to an apparatus for turning pages of a book and accommodation method for same

### 2. Description of the Related Art

As an apparatus which automatically turns pages of a book, a page turner has been conventionally known which turns overlapping pages one by one by sticking thereto (refer, for example, to Japanese Patent Application Laid-Open (Kokai) Publication No. 2016-010907). This page turner mainly includes a page-turning main body section, a holding table, and an imaging apparatus stand.

The page-turning main body section includes an arm which reciprocates on a circular arc trajectory, a sticking section which is provided at a distal end of the arm and sticks to pages of an opened book held on the holding table one by one and turns over each page, a driving section (motor) which drives the arm and the sticking section, an air blowing section which blows air toward the rear side of a turned page so that the page does not return to its page-turning start point, a control system (an electronic circuit; including a power supply circuit) which controls respective operations of the driving section, the air blowing section and the like.

Here, while air is being blown toward the rear side of the page being turned by the sticking section from the air blowing section arranged above the page-turning start point of the book, the page is guided to its page-turning end point after it is separated from the sticking section, and thereby prevented from returning to its page-turning start point. In the process of sequentially turning pages, the pages are sequentially photographed with a camera in a tablet or the like placed on the imaging apparatus stand, whereby the digitization of the book is achieved.

### SUMMARY OF THE INVENTION

In accordance with an aspect of the present invention, there is provided an apparatus for turning pages of an opened book, comprising: a holding table which holds the opened book by a pair of holding plates; a main body section which holds a page of the opened book at a page-turning start point by a sticking section, and turns over the page toward a page-turning end point by the sticking section; and a casing which is constituted by a plurality of constituent surfaces including a constituent surface where the holding table is fixed, and accommodates the holding table and the main body section in a rectangular parallelepiped shape.

In accordance with another aspect of the present invention, there is provided an accommodation method for an apparatus for turning pages of an opened book, comprising: accommodating a holding table which holds the opened book by a pair of holding plates and a main body section which holds a page of the opened book at a page-turning start point by a sticking section and turns over the page toward a page-turning end point by the sticking section, in a manner that the holding table and the main body section are accommodated in a rectangular parallelepiped shape by a casing constituted by a plurality of constituent surfaces including a constituent surface where the holding table is fixed.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention

### BRIEF DESCRIPTION OF THE DRAWINGS

The present invention can be more clearly understood by the detailed description below when considered together with the following drawings.

FIG. 1 is a perspective view showing a schematic structure of a page turner according the present embodiment;

FIG. 2A is a top view showing the structure of the casing of the page turner, and FIG. 2B is a perspective view showing an accommodated state of the page turner;

FIG. 3A and FIG. 3B are perspective views each showing the accommodated state of the page turner;

FIG. 4A and FIG. 4B are perspective views of the page turner which is in the middle of transition from the accommodated state to a usage state so as to be used;

FIG. 5A is a diagram showing an expansion unit for the page turner, and FIG. 5B is a diagram showing a state where the expansion unit has been attached to the page turner;

FIG. 5A and FIG. 6B are diagrams each showing a state of a page-turning main body section when the page turner is accommodated;

FIG. 7A and FIG. 7B are diagrams each showing a state of the page-turning main body section when the page turner is used;

FIG. 8A is an exploded view showing the structure of an imaging apparatus stand, and FIG. 8B is a side view showing the accommodated state of the imaging apparatus stand;

FIG. 9 is a side view showing the structure of the imaging apparatus stand when in use;

FIG. 10A and FIG. 10B are top views for describing a method for fixing the imaging apparatus stand;

FIG. 11 is a top view showing the structure of a casing which is also used as an installation sheet for the page turner;

FIG. 12 is an external view showing the structure of another imaging apparatus stand of the page turner;

FIG. 13 is a perspective view of the imaging apparatus stand in an accommodated state;

FIG. 14 is a perspective view of the imaging apparatus stand when it is used;

FIG. 15A and FIG. 15B are perspective views for describing an engagement mechanism for a stage and a leg section by the imaging apparatus stand;

FIG. 16 is a perspective view for describing the structure of a lifting mechanism by the imaging apparatus stand;

FIG. 17A and FIG. 17B are perspective views for describing the structure of a lifting button for the imaging apparatus stand, and FIG. 17C is a side view of the lifting button;

FIG. 18A and FIG. 18B are perspective views for describing a state occurring when the height of the leg section to which the stage has been fixed is adjusted in the imaging apparatus stand;

FIG. 19A and FIG. 19B are perspective views for describing a state where the height of the leg section to which the stage has been fixed is fixed in the imaging apparatus stand;

FIG. 20 is a top view showing the structure of a part of a casing for describing another guide sheet according to the present embodiment;

FIG. 21 is a top view for describing an installation position guide on a guide sheet;

FIG. 22 is a top view for describing an installation position guide on the guide sheet; and

FIG. 23 is a top view for describing an installation position guide on the guide sheet.

### DETAILED DESCRIPTION OF THE PREFERRED EMBODIMENT

A preferred embodiment of the present invention will hereinafter be described with reference to the accompanying drawings. Note that, although the embodiment described below is provided with various technically preferable limitations in order to carry out the present invention, these limitations are not intended to limit the scope of the present invention to the embodiment and examples shown in the drawings.

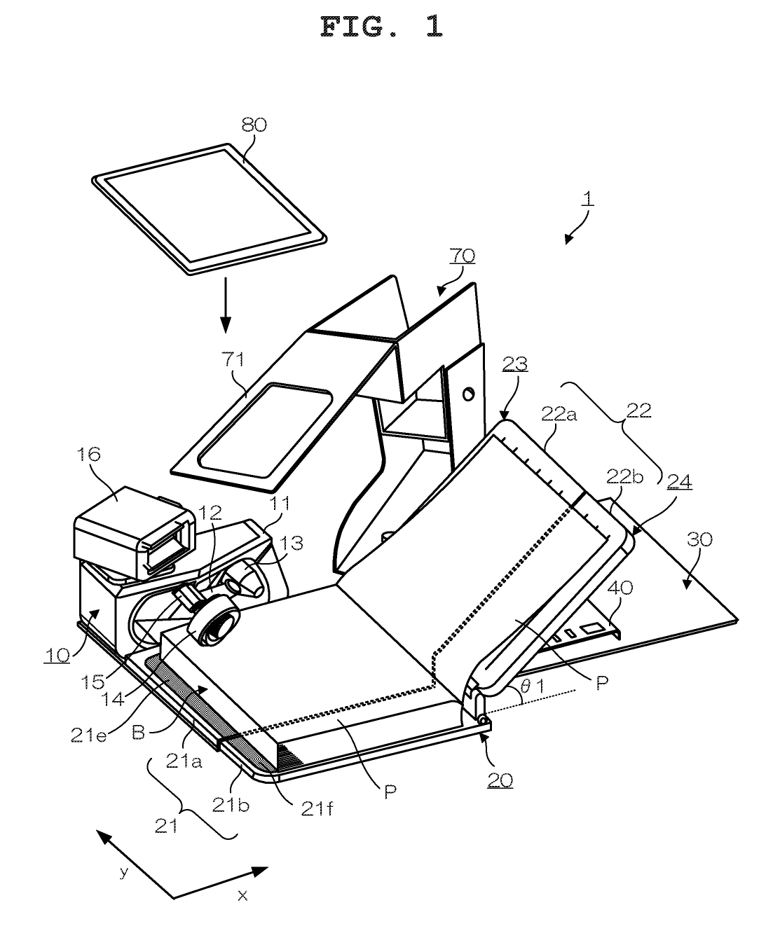

FIG. 1 is a perspective view showing the outer appearance of a page turner 1 according to an embodiment of the present invention. Note that in the following descriptions a case is described in which pages P of a book B are turned from left to right. In FIG. 1, the page turner 1 mainly includes a page-turning main body section (also simply referred to as a main body section) 10 which turns pages P of the book B, a holding table 20 which holds the opened book B, a casing 30 which covers the page-turning main body section 10 and the holding table 20 when the page turner 1 is accommodated, and an imaging apparatus stand (also simply referred to as a stand) 70 on which an information processing terminal (a smartphone, a tablet, etc.) 80 including imaging means for imaging pages P of the book B is placed. Note that the page turner 1 may separately include a page holding section which holds a turned page P at a page-turning end point, and a book holder which fixes the book B held by the holding table 20, although not shown.

The page-turning main body section 10 includes an accommodation case 11 having a substantially rectangular parallelepiped shape, an arm section 12 which can be accommodated in the accommodation case 11, a first driving section 13 such as a motor which swings the arm section 12 from right to left and from left to right, a sticking section 14 which is attached to a distal end of the arm section 12 and sticks to a page P of the book B, a second driving section 15 such as a motor which rotates the sticking section 14, an air blowing section 16 which makes air pass above pages P at a page-turning start point and blows air against a page P being turned by the sticking section 14 so as to assist the page-turning operation or separates the page P from the sticking section 14, and a control section not shown which controls respective operations of the sections. The page-turning main body section 10 is independent from the holding table 20, and its position and direction with respect to the holding table 20 can be adjusted as needed, based on the size of the book B.

Also, the air blowing section 16 is independent from the accommodation case 11 having a page-turning mechanism (structure) constituted by the arm section 12, the first driving section 13, the sticking section 14, and the second driving section 15. By the air blowing section 16 being independent from the accommodation case 11, the size (capacity) of the accommodation case 11 can be reduced. In addition, the degree of flexibility for arrangement of the air blowing section 16 can be improved.

More specifically, the independently provided air blowing section 16 is rotatable with respect to the accommodation case 11. When the blowing section 16 is to be accommodated, it is rotated and moved toward a side surface of the accommodation case 11 so as to be at a position where the air blowing section 16 and the accommodation case 11 are aligned and the upper surface of the accommodation case 11 and the air blowing port of the air blowing section 16 are substantially flush with each other, whereby the horizontal size (a size in an x-axis direction) of an area occupied by the moved air blowing section 16 and the accommodation case 11 fits within the horizontal size of a predetermined book, e.g., the A4 horizontal size. As a result of this design, the height of the page-turning main body section 10 when it is accommodated (corresponding to the width when accommodated) can be made smaller than that of a conventional page-turning main body section (having structure where an air blowing section and an accommodation case are integrally provided), and the horizontal size when it is accommodated becomes equal to the horizontal size of a predetermined book, e.g., the A4 horizontal size (the size of a predetermined book is hereinafter described as the A4 size), whereby the page turner 1 can be compactly accommodated.

Also, the air blowing section 16 is rotatably fixed to a fixing table described below. Accordingly, when the air blowing section 16 is to be used, it is rotated and moved toward the upper surface of the accommodation case 11 while being rotated in a horizontal direction with respect to the fixing table, so that the air blowing direction thereof is adjusted on a horizontal plane such that air is blown onto a page P being turned by the sticking section 14, as shown in FIG. 1. Also, by this structure where the air blowing section 16 is independently provided, a reduction in the size (capacity) of the accommodation case 11 is achieved, which enables the page turner 1 to be compactly accommodated and the weight thereof to be reduced.

The holding table 20 includes a pair of holding plates 21 and 22 which are foldable by a hinge. Here, in the case where pages P of the book B are turned from left to right one holding plate 21 arranged on the left side in the pair of holding plates 21 and 22 is placed along the top of the table, and the other holding plate 22 arranged on the right side is placed on the table while being inclined to rise at a predetermined angle to the one holding plate 21. On the one holding plate 21, the book B whose pages P have not been turned is placed. That is, a position on the side of the one holding plate 21 becomes a page-turning start point of each page P. On the other holding plate 22, turned pages P are held. That is, a position on the side of the other holding plate 22 becomes a page-turning end point of each page P.

As a result, the holding table 20 holds the book B such that pages P at page-turning end points are more inclined in a direction to rise with respect to the seam of the book B than pages P at page-turning start points. Note that since the pair of holding plates 21 and 22 are foldable by the hinge, an angle formed between the paired holding plates 21 and 22 can be adjusted and a tilt angle θ1 of a pages P at a page-turning end point with respect to the horizontal plane is adjustable. The tilt angle θ1 is preferably adjusted in a range of 30° to 45′.

Also, the holding table 20 can be divided so that it fits within the A4 size as a whole when the page turner 1 is accommodated. More specifically, the holding table 20 has a main body section 23 including holding plates 21a and 22a and an expansion unit 24 including holding plates 21b and 22b, and can be divided into the main body section 23 and the expansion unit 24. More specifically, the page turner 1 is designed such that, when it is to be accommodated, the vertical size (a size in a y-axis direction) of an area occupied by the holding plates 21a and 22a and the page-turning main body section 10 fits within the A4 vertical size by the expansion unit 24 being removed. Also, the pair of holding plates 21 and 22 of the holding table 20 holds the book B such that pages P at page-turning end points are more inclined in a direction to rise with respect to the seam of the book B than pages P at page-turning start points, and therefore the holding plates 21a and 21b constituting the holding plate 21 at a page-turning start point should preferably be provided with non-slip sheets 21e and 21f.

As such, the horizontal size (a size in an x-axis direction) of the area occupied by the holding plates 21a and 22a and the page-turning main body section 10 fits within the A4 horizontal size by the air blowing section 16 being rotated and moved toward the side surface of the accommodation case 11, and the vertical size (a size in a y-direction) of the area occupied by the holding plates 21a and 22a and the page-turning main body section 10 fits within the A4 vertical size by the expansion unit 24 being removed from the main body section 23. That is, the vertical and horizontal size of the area occupied by the holding plates 21a and 22a and the page-turning main body section 10 can fit within the A4 size when the page turner 1 is accommodated.

Also, the sizes of the respective sections are designed such that any book up to the A4 size can be placed on the holding table 20 by the expansion unit 24 being mounted on the main body section 23 so as to expand the size of the holding table 20 when the page turner 1 is used. As a result, the downsizing of the page turner 1 for accommodation is achieved without affecting its page-turning operation.

The casing 30 functions as an installation sheet for preventing the page-turning main body section 10 and the holding table 20 from shifting when the page turner 1 is used, and functions as a cover for covering the page-turning main body section 10 and the holding table 20 when the page turner 1 is accommodated. The main body section 23 including the holding plates 21a and 22a is fixed to the casing 30. A guide (illustration) for guiding a user about an installation position of the page-turning main body section 10 and an installation position of the imaging apparatus stand 70 on the holding plate 20 is written inside the casing 30, details of which will be described below. Also, the casing 30 is provided with a support section 40 which supports the holding plate 22 at predetermined angles (several levels). The support section 40 is provided with a groove that supports a stand not shown which is arranged on a back portion of the holding plate 22 at predetermined angles (multiple levels).

The imaging apparatus stand 70 includes a stage 71 extending in a direction diagonal to a page P at a page-turning start point of the opened book B (a page P which has not been turned) serving as an imaging target and parallel to the installation surface of the imaging apparatus stand 70. On the stage 71, the information processing terminal 80 such as a tablet terminal is placed as an imaging apparatus, and a camera in the information processing terminal 80 photographs a page P at a page-turning start point (a page which has not been turned) via an opening portion provided in the stage 71. The installation position of the imaging apparatus stand 70 is written on the above-described guide (illustration) written in the casing 30. Therefore, an installation sheet on which an installation position is written for each size of the book B need not be separately prepared, which eliminates time and work to prepare the installation sheet and install each of the units. Accordingly, the imaging apparatus stand 70 can be easily installed at an appropriate position.

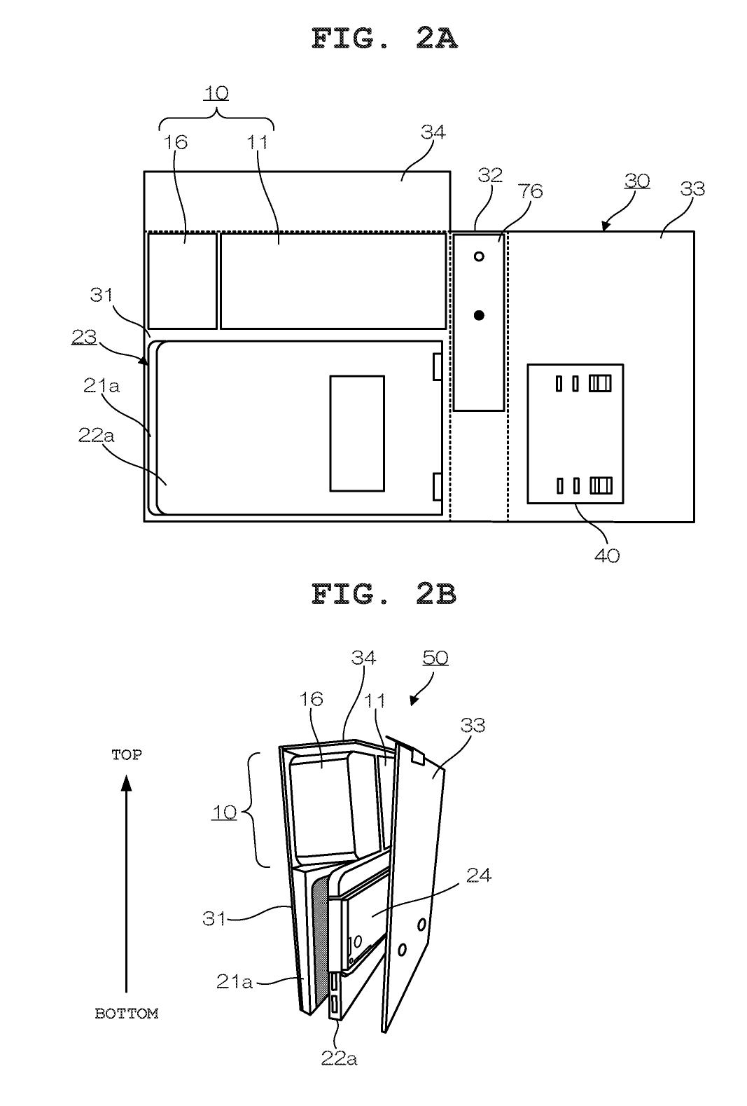

FIG. 2A is a top view showing the structure of the casing 30 in the page turner 1, and FIG. 2B is a perspective view showing a state where the page turner 1 is accommodated.

In the present embodiment, the casing 30 includes at least four constituent surfaces 31, 32, 33 and 34 constituting a substantially rectangular parallelepiped by folding its broken-line portion inward, as shown in FIG. 2A. The respective vertical and horizontal sizes of the two constituent surfaces 31 and 33 among the four constituent surfaces 31 to 34 are the A4 size, the one constituent surface 32 among the four constituent surfaces 31 to 34 couples the two constituent surfaces 31 and 33 of the A4 size to form a back portion, and the constituent surface 34 among the four constituent surfaces 31 to 34 is coupled to the constituent surface 31 of the A4 size. When the page turner 1 is to be accommodated, the holding table 20 is folded, and the air blowing section 16 is rotated and moved toward the side surface of the accommodation case 11 so that the upper surface of the accommodation case 11 and the air blowing port of the air blowing section 16 are substantially flush with each other, the expansion unit 24 is removed from the main body section 23, and the broken-line portion of the casing 30 is folded inward, whereby the page-turning main body section 10 including the accommodation case 11 and the air blowing section 16 and the holding table 20 (the holding plate 21a and the holding plate 22a) are covered. Note that the folding plate 21a of the main body section 23 is fixed to the constituent surface 31. As a result, the entire casing 30 can have a substantially rectangular parallelepiped shape constituted by at least the four constituent surfaces 31, 32, 33 and 34 (the entire portion constituting the substantially rectangular parallelepiped shape is hereinafter referred to as a main body unit 50), as shown in FIG. 2B. Also, the expansion unit 24 is removed from the main body section 23, folded, and accommodated with it being interposed between the holding plate 21a and the holding plate 22a of the folded holding table 20.

Here, the main body unit 50 is accommodated with the page-turning main body section 10 being on the upper side and the holding plate 21a and the holding plate 22a being on the lower side for workability at the time of use. That is, by the main body unit 50 being installed such that the page-turning main body section 10 is on the far side from the user and the holding table 20 is on the near side, page-turning operations can be easily performed when the page turner 1 is used. By the main body unit 50 being accommodated with the page-turning main body section 10 being on the upper side and the holding plate 21a and the holding plate 22a being on the lower side, the main body unit 50 is naturally installed such that the page-turning main body section 10 is on the far side and the holding table 20 is on the near side when the casing 30 is unfolded so as to use the page turner 1, as shown in FIG. 2B. Also, by the main body unit 50 being accommodated with the page-turning main body section 10 being on the upper side and the holding plate 21a and the holding plate 22a being on the lower side as described above, the page-turning main body section 10 can, he supported from below by the holding table 20 (the holding plate 21a and the holding plate 22a) without special support means being provided.

Note that, on the constituent surface 32 corresponding to the back portion of the casing 30, a stand, installation plate (mounting plate) 76 to which the imaging apparatus stand 70 is rotatably fixed is provided, details of which will be described below.

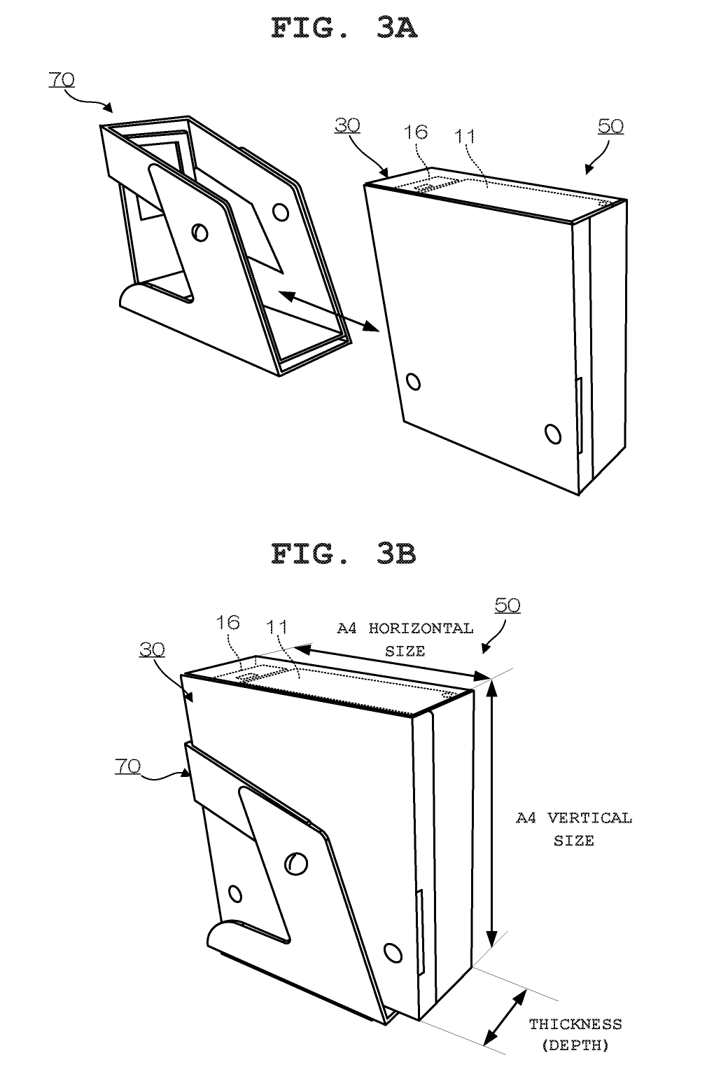

FIG. 3A and FIG. 3B are perspective views each showing a state where the page turner 1 is accommodated. When the page turner 1 is to be accommodated, the substantially rectangular parallelepiped main body unit 50 is inserted between a pair of leg sections constituting the imaging apparatus stand 70, as shown in FIG. 3A. The sizes of sections such as the page-turning main body section 10 and the holding table 20, spacing between the leg sections constituting the imaging apparatus stand 70, and the like have been designed such that the length of the main body unit 50 is of the A4 vertical size, the depth of the main body unit 50 is of the A4 horizontal size, and the main body unit 50 has a thickness (depth) that allows it to be within the spacing between the leg sections constituting the imaging apparatus stand 70. Also, the sizes of the sections (e.g., the height of the page-turning main body section 10 and the height of the holding table 20 at the time of folding) have been designed such that the substantially rectangular parallelepiped main body unit 50 is positioned within the spacing between the leg sections constituting the imaging apparatus stand 70. By having a substantially A4 size for accommodation, the main body unit 50 can be easily stored in an ordinary cabinet, bookcase or the like. Also, by the structure where the imaging apparatus stand 70 is used as a file folder when the main body unit 50 is accommodated, the accommodation of the imaging apparatus stand 70 itself is not required to be considered.

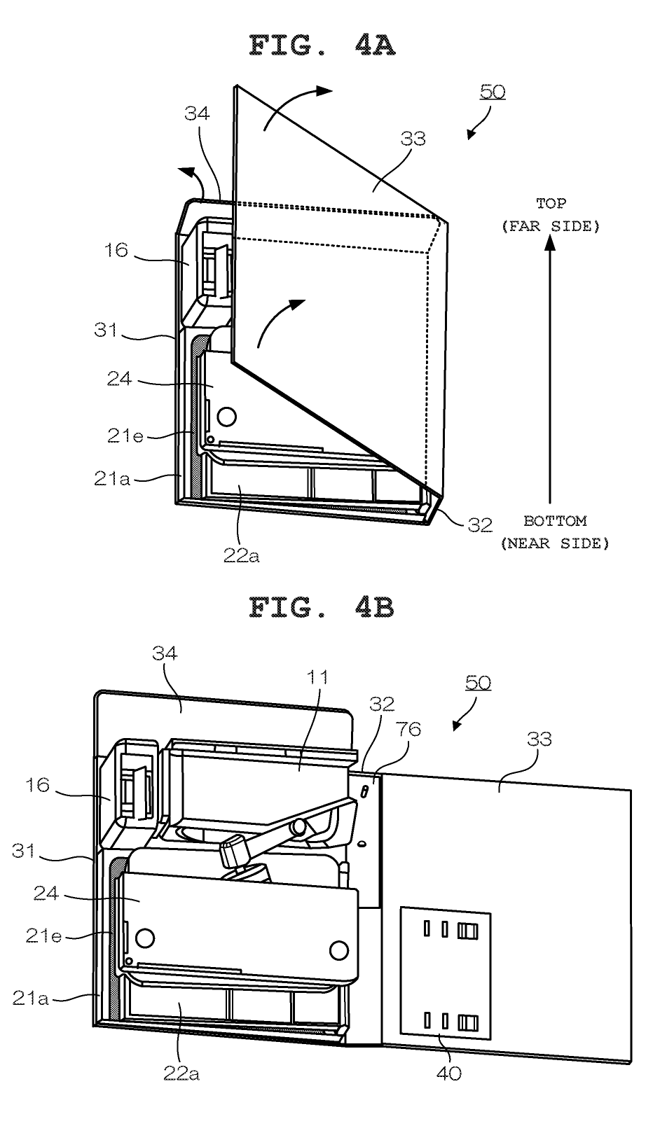

FIG. 4A and FIG. 4B are perspective views each showing a state of the page turner 1 in the middle of transition from an accommodated state to a usage state so as to be used. When the page turner 1 is to be used, the main body unit 50 taken out of the imaging apparatus stand 70 is placed on a desk or the like such that the upper side and the lower side of the main body unit 50 are on the far side and the near side from the user, and the three constituent surfaces 32, 33 and 34 of the casing 30 are unfolded, as shown in FIG. 4A. FIG. 4B shows a state where the casing 30 has been unfolded. Here, the folding plate 21a of the main body section 23 is fixed to the constituent surface 31. Accordingly, by the three components 32, 33 and 34 being unfolded with the constituent surface 31 being on the lower side, the casing 30 is unfolded with the holding plate 21a of the main body section 23 being arranged at a predetermined position. That is, the casing 30 is unfolded such that the user can easily proceed to the subsequent setting operation.

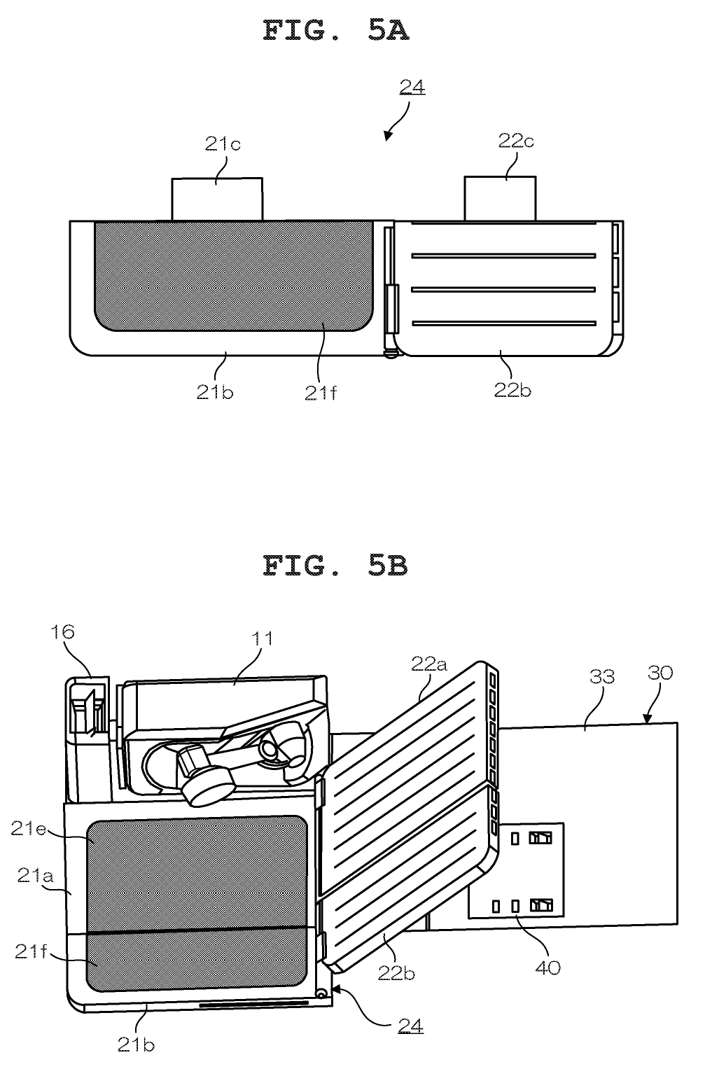

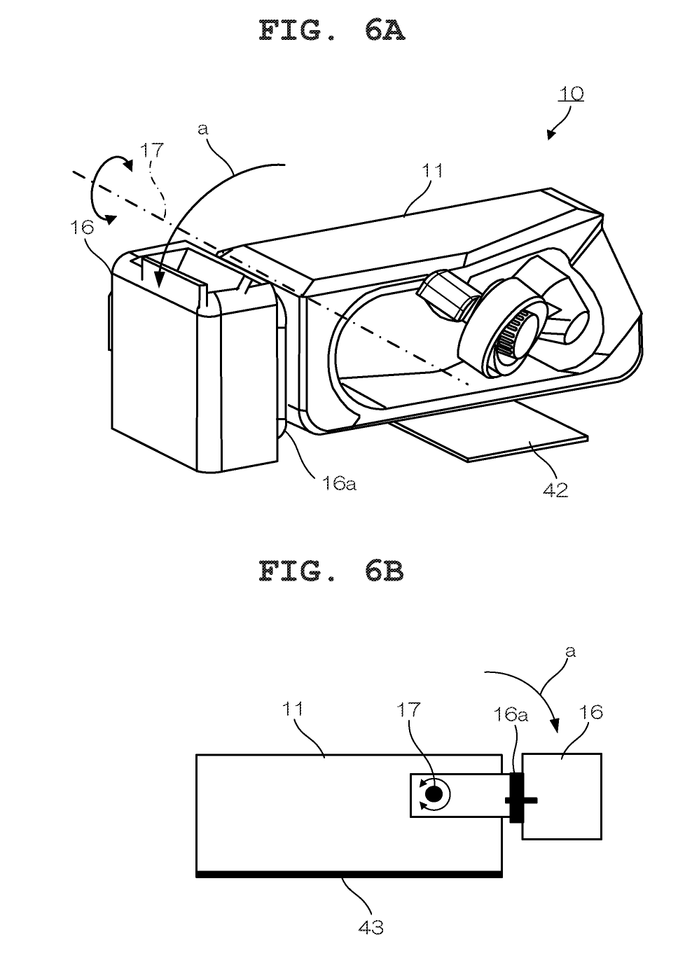

FIG. 5A is a diagram showing the expansion unit 24 for the page turner 1, and FIG. 5B is a diagram showing a state where the expansion unit 24 has been attached to the page turner 1. The expansion unit 24 includes the pair of holding plates 21b and 22b which are foldable by a hinge. The holding plates 21b and 22b include insertion plates 21c and 22c for positioning and fixing the holding plates 21b and 22b on the holding plates 21a and 22a by being inserted into slits (not shown) provided in side portions of the holding plates 21a and 22a. After the casing 30 is unfolded as described above, the expansion unit 24 is mounted on the side portions of the holding plates 21a and 22a, as shown in FIG. 5B. As such, by the holding plates 21 and 22 being dividable into the holding plates 21a and 22a and the expansion unit 24 including the holding plates 21b and 22b, the main body unit 50 can be compactified (in the A4 size) for accommodation and during usage can be used for book B of maximum A4 size.

FIG. 6A and FIG. 6B are diagrams each showing a state of the page-turning main body section 10 when the page turner 1 is accommodated. The air blowing section 16 is fixed to a fixing table 16a connected to the accommodation case 11 in a manner to be rotatable around a rotation axis 17. When being accommodated, the air blowing section 16 is rotated around the rotation axis 17 in a direction indicated by arrow “a” and thereby laterally positioned. In the state where the air blowing section 16 has been laterally positioned, the height of the air blowing port of the air blowing section 16 and the height of the accommodation case 11 are substantially flush with each other, so that stability at the time of accommodation is ensured, as shown in FIG. 6A and FIG. 6B. Also, on the bottom of the accommodation case 11, an insertion plate 42 is provided which prevents the page-turning main body section 10 from shifting during a page-turning operation by being inserted into a slit (not shown) provided in a side portion of the holding plate 21a in the holding table 20 when the page-turning main body section 10 is arranged on the casing 30. Further, a non-slip sheet 43 for preventing the page-turning main body section 10 from shifting during a page-turning operation is attached to the bottom surface of the accommodation case 11. Accordingly, a weight to prevent the book B from shifting is not required for the page-turning main body section 10 itself, whereby the page turner 1 can be downsized and the weight can be reduced.

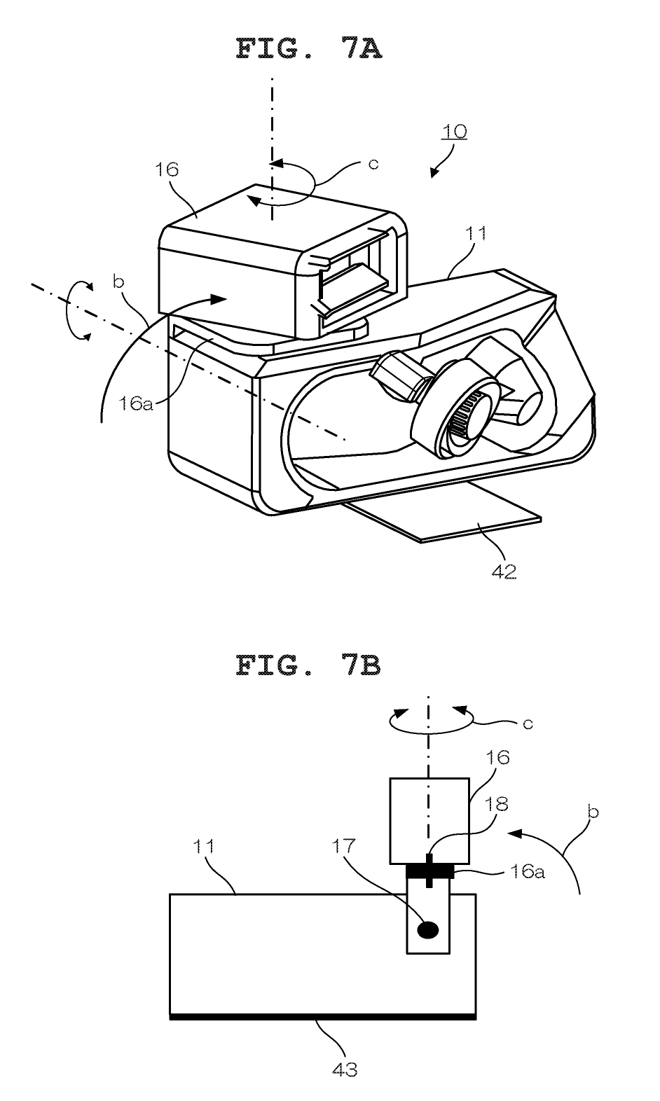

FIG. 7A and FIG. 7B are diagrams each showing a state of the page-turning main body section 10 when the page turner 1 is used. When the page turner 1 is to be used, the air blowing section 16 is rotated around the rotation axis 17 in a direction indicated by arrow “b” so as to be moved to an area above the accommodation case 11, and is rotated around a rotation axis 18 of the fixing table 16a in a horizontal direction indicated by arrow “c”, whereby the direction of air from the air blowing section 16 can be adjusted such that the air is blown onto a page P being turned by the sticking section 14.

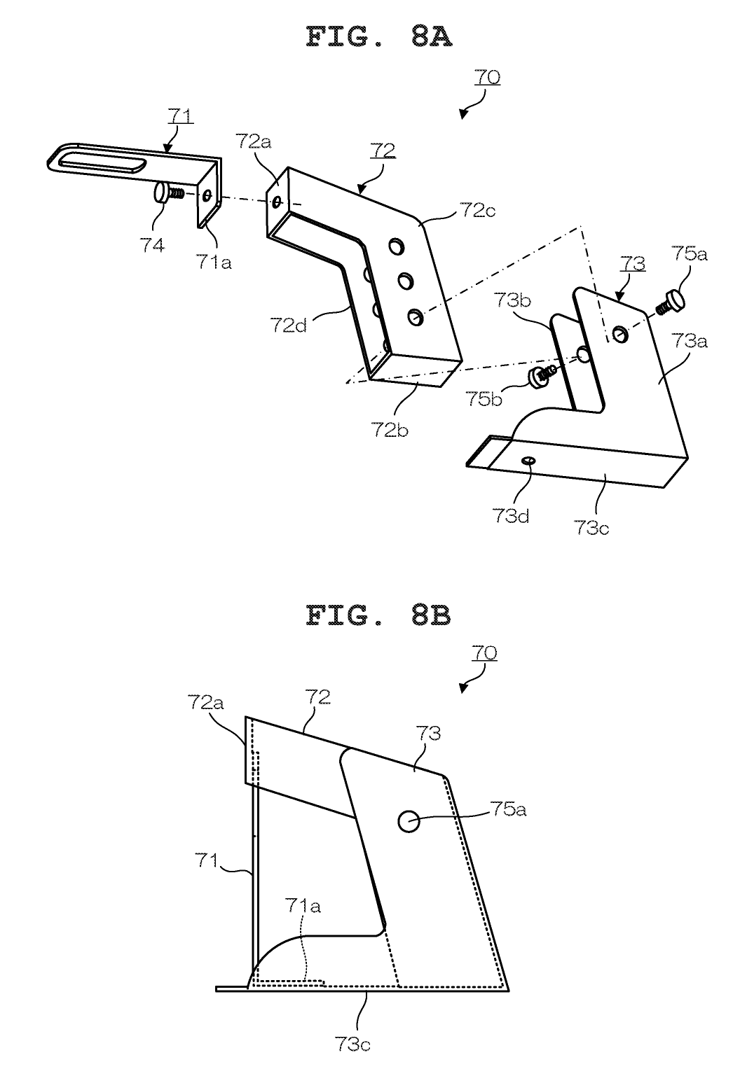

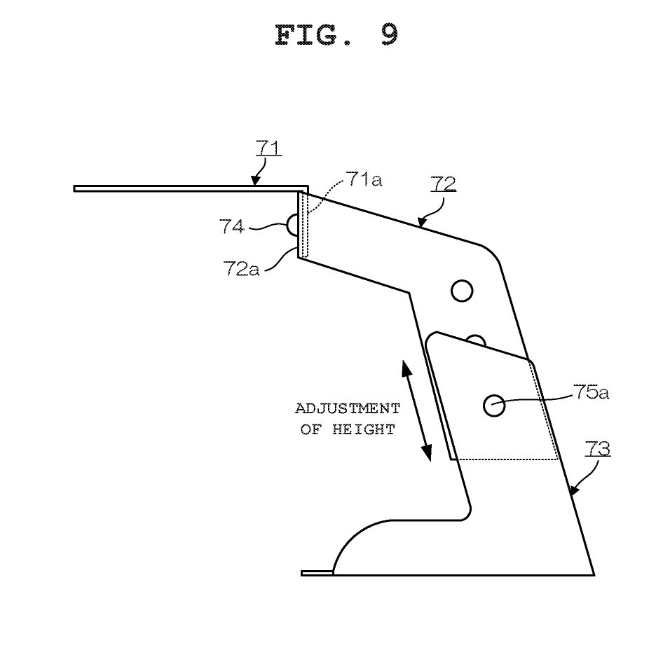

FIG. 8A is an exploded view showing the structure of the imaging apparatus stand 70, and FIG. 8B is a side view showing the accommodated state of the imaging apparatus stand 70. FIG. 9 is a side view showing the structure of the imaging apparatus stand 70 when in use.

The imaging apparatus stand 70 includes a stage 71 on which the information processing terminal 80 such as a tablet terminal is placed and leg sections 72 and 73 each structured such that its height is adjustable, as shown in FIG. 8B. The stage 71 includes a fixing plate 71a bent at an angle of 90° with respect to a placement surface on which the information processing terminal 80 is placed, and is fixed to the leg section 72 when the fixing plate 71a is fixed to a distal end plate 72a of the leg section 72 with a screw 74. Note that a fixing means and a fixing method therefor are not limited. For example, the stage 71 and the leg section 72 may be fixed by being fitted together without using the screw 74.

The leg section 72 includes the above-described distal end plate 72a, a bottom plate 72b, and side plates 72c and 72d connected to each other at predetermined intervals by the distal end plate 72a and the bottom plate 72b such that the main body unit 50 is supported from both side surfaces when the main body unit 50 is inserted thereinto for accommodation as described above. In the side plates 72c and 72d, a plurality of paired holes vertically arranged at predetermined intervals are formed.

On the other hand, the leg section 73 includes side plates 73a and 73b for fixing the leg section 72 (e.g., the stage 71) at a desired height and a bottom plate 73c for connecting the side plates 73a and 73b at a predetermined interval. In the side plates 73a and 73b, paired holes are respectively formed at the corresponding positions. The leg section 72 and the leg section 73 are fixed to each other by a pair of screws 75a and 75b with one of the plurality of paired holes on the side plates 72c and 72d of the leg section 72 and the paired holes on the side plates 73a and 73b of the leg section 73 being aligned with each other. Since the plurality of paired holes vertically arranged at predetermined intervals are formed in the side plates 72c and 72d in the leg section 72, the height of the stage 71 can be adjusted in accordance with the viewing angle of the camera in the information processing terminal 80, the size of the book B, or the like by changing holes into which the screws 75a and 75b are inserted. Note that a fixing means and a fixing method therefor are not limited. For example, the leg section 72 and the leg section 73 may be fixed by being fitted together without using the screws 75a and 75b. In the bottom plate 73c of the leg section 73, a hole 73d for fixing the leg section 73 to the casing 30 with a screw is formed. A method for fixing the leg section 73 will be described later.

FIG. 8B shows a state of the imaging apparatus stand 70 when the page turner 1 is accommodated. When the page turner 1 is to be accommodated, the imaging apparatus stand 70 is placed such that the stage 71 is removed from the leg section 72, the fixing plate 71a is brought into contact with the bottom plate 73c of the leg section 73, and a distal end of the stage 71 is brought into contact with the inner side of the distal end plate 72a of the leg section 72. By this structure, the imaging apparatus stand 70 can reliably hold the substantially rectangular parallelepiped main body unit 50. Note that the above-described structure of the imaging apparatus stand 70 is merely an example. For example, the stage 71 may be moved to a predetermined position by using a rotation mechanism without being removed from the leg section 72.

When the page turner 1 is to be used, the fixing plate 71a of the stage 71 is inserted into the distal end plate 72a in the leg section 72 and is fixed thereto with the screw 74, as shown in FIG. 9. Then, the height of the leg section 72 is adjusted in accordance with the viewing angle of the camera in the information processing terminal 80, the size of the book B, or the like, and the leg section 72 is fixed to the leg section 73 with the screw 75a (75b). Note that although the imaging apparatus stand 70 is placed on the casing 30 when the page turner 1 is used, a non-slip sheet may be attached to the bottom plate 73e of the leg section 73 or the imaging apparatus stand 70 may be fixed to the casing 30 with a screw or the like to prevent an installation position from shifting during a page-turning operation.

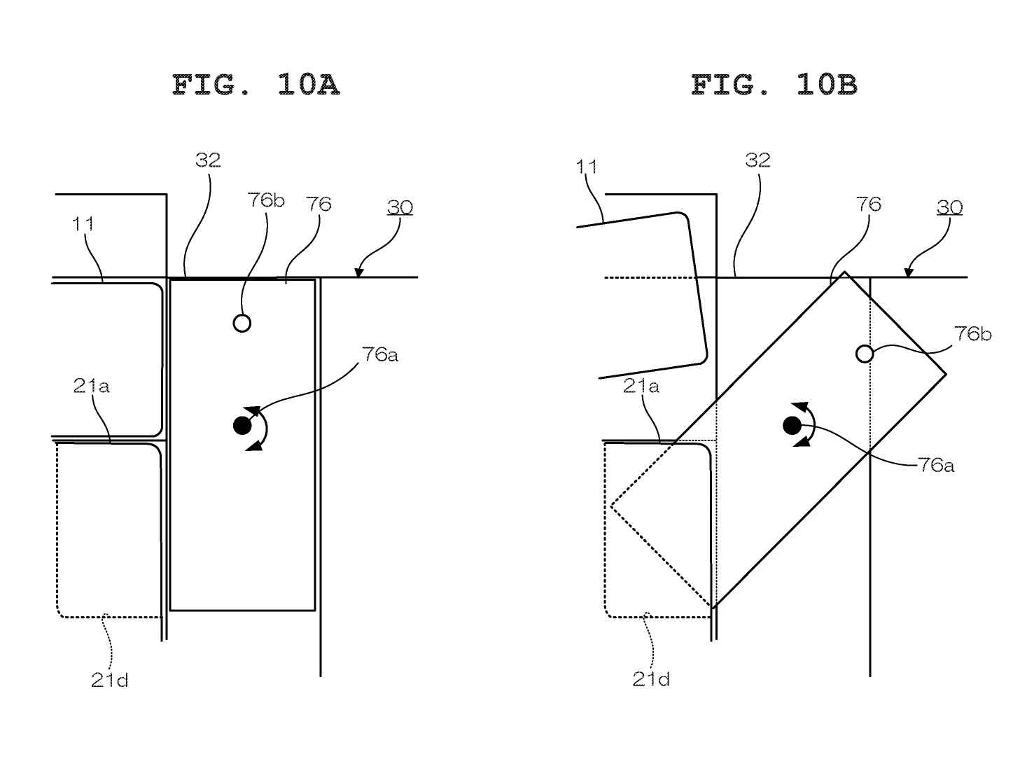

FIG. 10A and FIG. 10B are top views for describing a method for fixing the imaging apparatus stand 70. In the present embodiment, a stand installation plate 76 for fixing the imaging apparatus stand 70 at a predetermined angle is threadably mounted on the constituent surface 32 corresponding to the back portion of the casing 30, as shown in FIG. 10A. The stand installation plate 76 is horizontally rotatable by using the screw threadably mounted as the rotation axis 76a. At a predetermined position of the stand installation plate 76, a male screw (fixing section) 76b is provided.

When using the page turner 1, the user places the imaging apparatus stand 70 on the stand installation plate 76 such that the male screw 76b is inserted into the hole 73d formed in the bottom plate 73c of the leg section 73. Then, a cap (not shown) provided with a female screw is screwed into the male screw 76b so as to fix the imaging apparatus stand 70 on the stand installation plate 76.

Then, the user rotates the stand installation plate 76 around the rotation axis 76a in the horizontal direction and thereby adjusts the direction of the imaging apparatus stand 70 such that the opening section in the stage 71 is positioned above a page P of the book B placed on the holding plate 21a, as shown in FIG. 10B. In the side portion of the holding plate 21a, a slit 21d is formed, so that a part of the rotated stand installation plate 76 enters the above-described slit 21d.

As shown in FIG. 10A, the imaging apparatus stand 70 is designed such that the width of the stand installation plate 76 and the width of the constituent surface 32 are substantially the same or the width of the stand installation plate 76 is slightly smaller than the width of the constituent surface 32, as shown in FIG. 10A. Accordingly, when the page turner 1 is not being used, i.e., when accommodated, the stand installation plate 76 is arranged along the constituent surface 32 corresponding to the back portion of the casing 30 and therefore does not interfere with the accommodation. That is, the imaging apparatus stand 70 can be easily fixed to an appropriate installation position, and the position (orientation) of the imaging apparatus stand 70 can be easily adjusted.

Note that, in the present embodiment, a guide sheet 60 on which a guide (illustration) for guiding the user of the installation position of the page-turning main body section 10 and the installation position of the imaging apparatus stand 70 for each book size is written is attached (or printed) inside the casing 30, as described below. Accordingly, the stand installation plate 76 is constituted by a transparent acrylic plate to prevent the stand installation plate 76 from blocking the guide (illustration).

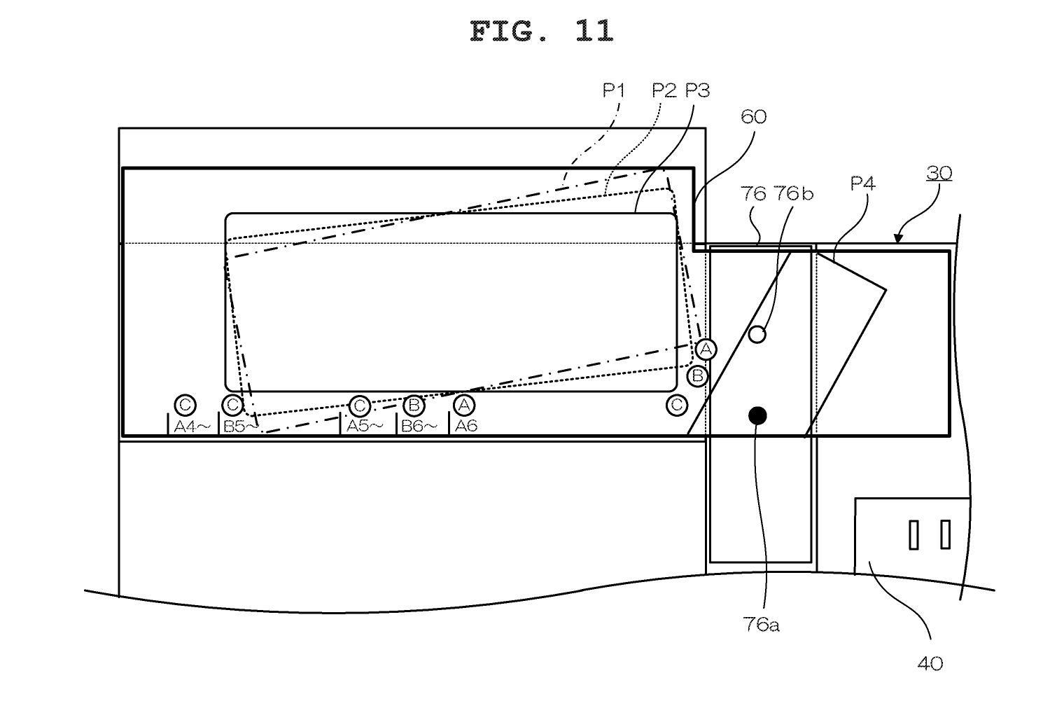

FIG. 11 is a top view showing the structure of a part of the casing 30 that is also used as the installation sheet for the page turner 1. Inside the casing 30 of the present embodiment, the guide sheet 60 on which the guide (illustration) for informing the user of the installation position of the page-turning main body section 10 and the installation position of the imaging apparatus stand 70 is written is attached (or printed). More specifically, markers (A6, B6˜, A5˜, B5˜ and A4˜) each representing a placement position on the holding plate 20 for each book size and symbols (A, B and C) each representing an installation position of the page-turning main body section 10 adapted to a book size with the holding table 20 on the casing 30 as a reference are written for each of the markers. On the guide sheet 60, installation position guides P1, P2, and P3 for the page-turning main body section 10 are written corresponding to the above-described symbols (A, B and C).

The user confirms the size of the book B to be placed and the marker corresponding to the size (A6, B6˜, A5˜, B5˜, A4˜) of the book B, places the book B on the holding table 20 such that it corresponds to the marker, confirms the symbols (A, B and C) written for the marker, and installs the accommodation case 11 of the page turning main body section 10 at one of the installation position guides P1(A), P2(B) and P3(C) respectively corresponding to the symbols (A, B and C). As a result, the page-turning main body section 10 will be installed at the installation position which matches the size of the book B. On the guide sheet 60, an installation position guide P4 at which the imaging apparatus stand 70 is installed is also written. The user can install the imaging apparatus stand 70 at an appropriate position by only rotating the stand installation plate 76 where the imaging apparatus stand 70 has been fixed to the installation position guide P4 written on the guide sheet 60.

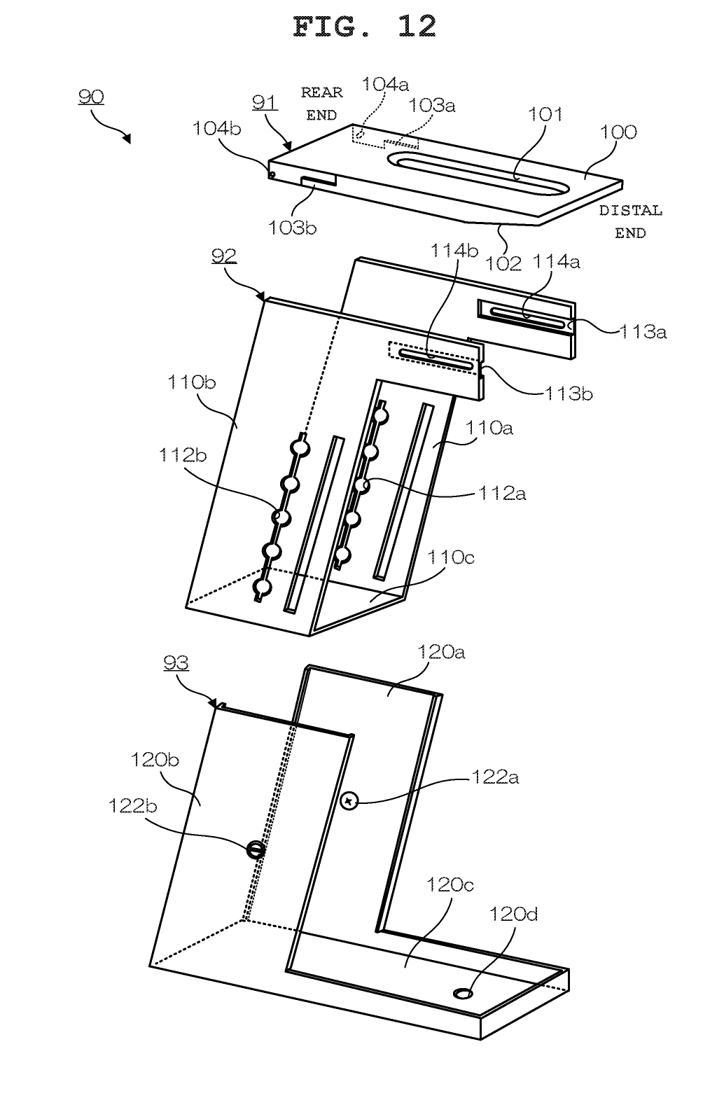

FIG. 12 is an external view showing the structure of another imaging apparatus stand 90 for the page turner 1. FIG. 12 shows a state of the imaging apparatus stand 90 when the page turner 1 is accommodated. The imaging apparatus stand 90 includes a stage 91 on which the information processing terminal 80 such as a tablet terminal is placed and leg sections 92 and 93 each structured such that its height is adjustable.

The stage 91 includes a placement surface 100 on which the information processing terminal 80 is placed, and the placement surface 100 is provided with an opening section 101 for exposing the camera in the information processing terminal 80 placed to be oriented downward. The opening section 101 is formed in an elongated shape along a longitudinal direction with respect to the stage 91. Also, a tapered section 102 is formed at the bottom of a distal end portion (on the right side as illustrated) of the stage 91 to ensure the viewing angle of the camera (to prevent vignetting due to the thickness of the stage 91). By this structure as well, a weight reduction is achieved.

Also, on both side surfaces of a rear end portion (on the left side of the drawing) of the stage 91, stoppers 103a and 103b for fixing the stage 91 to the leg section 92 in a horizontal state when the page turner 1 is used are formed. In addition, on both side surfaces of the rear end portion (on the left side of the drawing) of the stage 91, movable shafts 104a and 104b are provided. The function of the movable shafts 104a and 104b will be described later.

The leg section 92 includes side plates 110a and 110b and a bottom plate 110c which connects the side plates 110a and 110b to each other at predetermined intervals, and thereby supports the main body unit 50 from both side surfaces when the main body unit 50 is inserted thereinto for accommodation. In the side plates 110a and 110b, adjustment holes 112a and 112b for adjusting and fixing the height of the leg section 92 with respect to the leg section 93 are formed opposing each other. The function of the adjustment holes 112a and 112b will be described below.

Also, the side plates 110a and 110b each have a shape whose upper side projects forward, and groove sections 113a and 113b into which the stoppers 103a and 103b in the above-described stage 91 are inserted are respectively formed in the protruding portions. In the groove sections 113a and 113b, hole sections 114a and 114b into which the movable shaft 104a and 104 in the above-described stage 91 are inserted are respectively formed. The functions of the groove sections 113a and 113b and the hole sections 114a and 114b will be described later.

The leg section 93 includes side plates 120a and 120b for holding the leg section 92 (i.e., the stage 91) and fixing the leg section 92 at a desired height, and a bottom plate 120c for connecting the side plates 120a and 120b to each other at predetermined intervals. On the side plates 120a and 120b, paired lifting buttons 122a and 122b which are fitted into the adjustment holes 112a and 112b of the leg section 92 are provided at opposing positions. The function of the lifting buttons 122a and 122b will be described later. On the bottom plate 120c of the leg section 93, a hole 120d for fixing the leg section 93 to the casing 30 with a screw is formed.

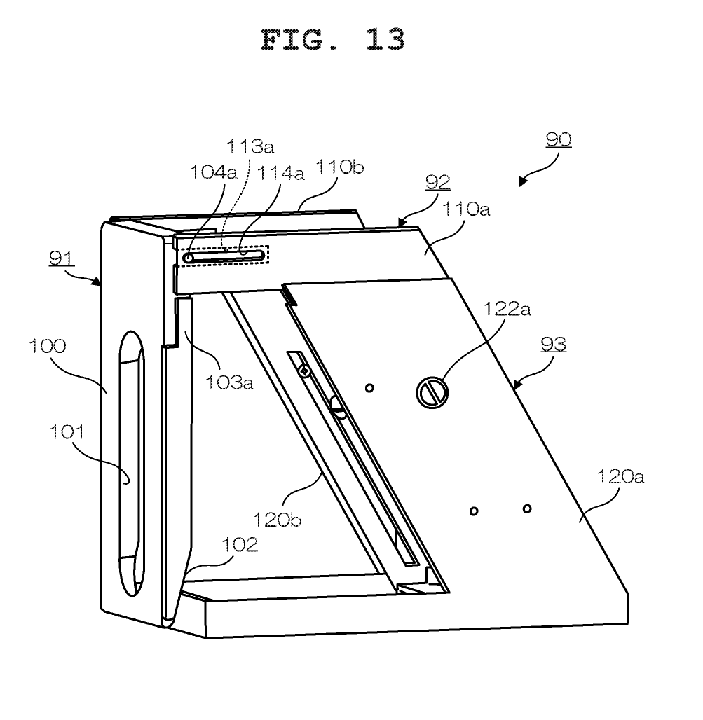

FIG. 13 is a perspective view showing the imaging apparatus stand 90 in an accommodated state. The leg section 92 is arranged inside the side plates 120a and 120b of the leg section 93, and the movable shafts 104a and 104b of the stage 91 are respectively inserted into the hole sections 114a and 114b formed on both side surfaces of a distal end portion of the leg section 92. At the time of accommodation, unlike the above-described imaging apparatus stand 70, this imaging apparatus stand 90 is rotated downward using the movable shafts 104a and 104b as rotation axes so as to put the placement surface 100 into a vertical state without the stage 91 being removed from the leg section 92. In this state, the substantially rectangular parallelepiped main body unit 50 shown in FIG. 2B is accommodated between the side plates 110a and 110b of the leg section 92.

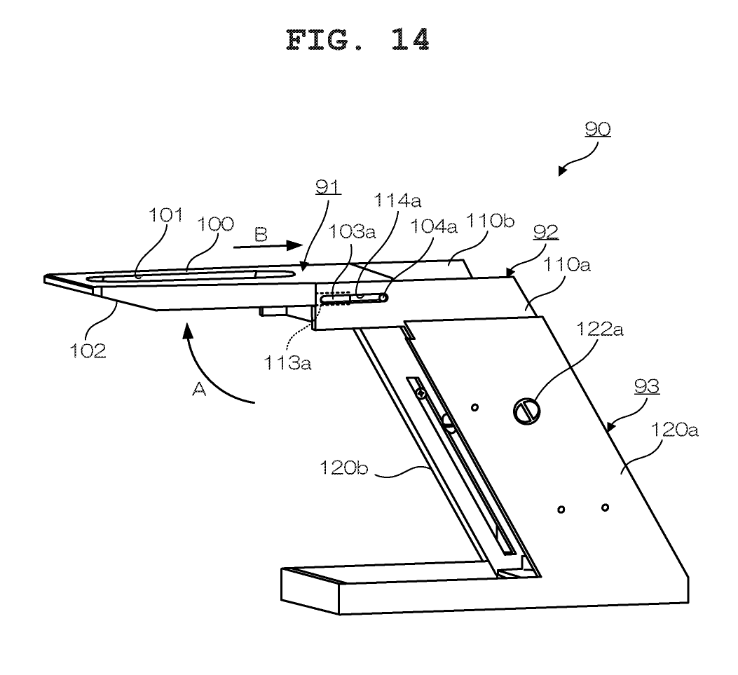

FIG. 14 is a perspective view showing the imaging apparatus stand 90 at the time of use. When the page turner 1 is to be used (when turning pages), the substantially rectangular parallelepiped main body unit 50 is taken out from between the side plates 110a and 110b of the leg section 92, the stage 91 is rotated (arrow A) using the movable shafts 104a and 104b as rotation axes until the placement surface 100 becomes horizontal, and then the stage 91 is slid backward along the hole sections 114a and 114b (arrow B). When the stage 91 is slid backward, the stoppers 103a and 103b formed in both side portions of the stage 91 are respectively inserted into the groove sections 113a and 113b of the leg section 92 so as to be engaged therewith. As a result, the stage 91 is reliably fixed to the leg section 92 in a horizontal state without being fixed thereto with a screw or the like.

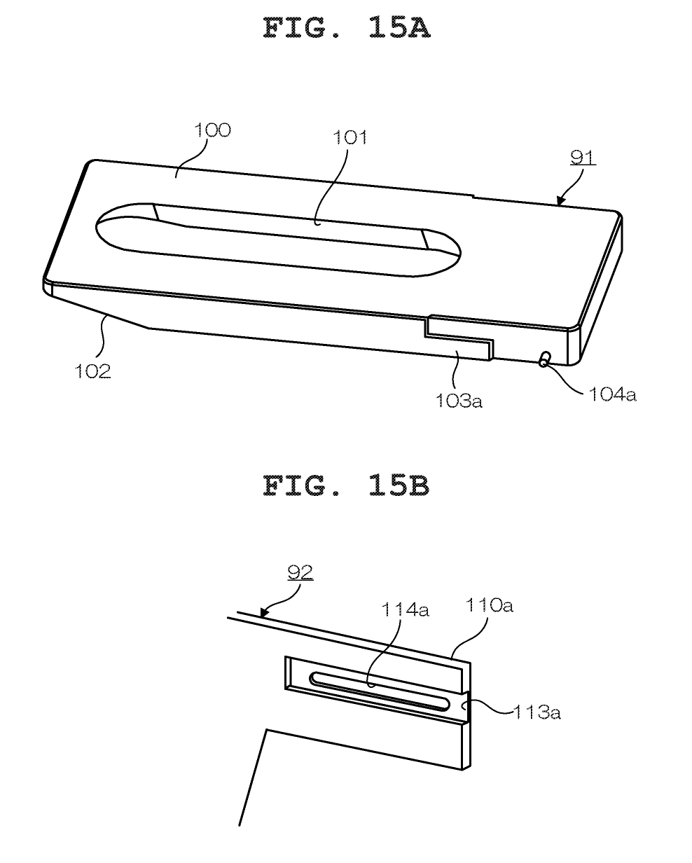

FIG. 15A and FIG. 15B are perspective views for describing an engagement mechanism between the stage 91 and the leg section 92 by the imaging apparatus stand 90. Note that, in FIG. 15A and FIG. 15B, a structure related to only one of surfaces is shown. Accordingly, in the following descriptions, a structure related the other surface is indicated by a symbol within parentheses. The movable shaft 104a (104b) of the stage 91 is inserted into the hole section 114a (114b) formed on the side surface of the distal end portion of the leg section 92. The stopper 103a (103b) on the side portion of the stage 91 is formed to correspond to the shape of the groove section 113a (113b) in the side surface of the distal end portion of the leg section 92. When the stage 91 is slid forward by the length of the stopper 103a (103b) being adjusted, an engagement between the stopper 103a (103b) and the groove section 113a (113b) is released. When the stage 91 is slid backward, the stopper 103a (103b) engages with the groove section 113a (113b).

As a result of this structure, the stage 91 can be rotated using the movable shaft 104a (104b) as a rotation axis when the stage is slid forward, and can be fixed when the stage 91 is slid backward. That is, at the time of accommodation, the stage 91 is slid forward and rotated downward, as shown in FIG. 13. At the time of use, the stage 91 is rotated to be in a horizontal state and then slid backward and fixed, as shown in FIG. 14.

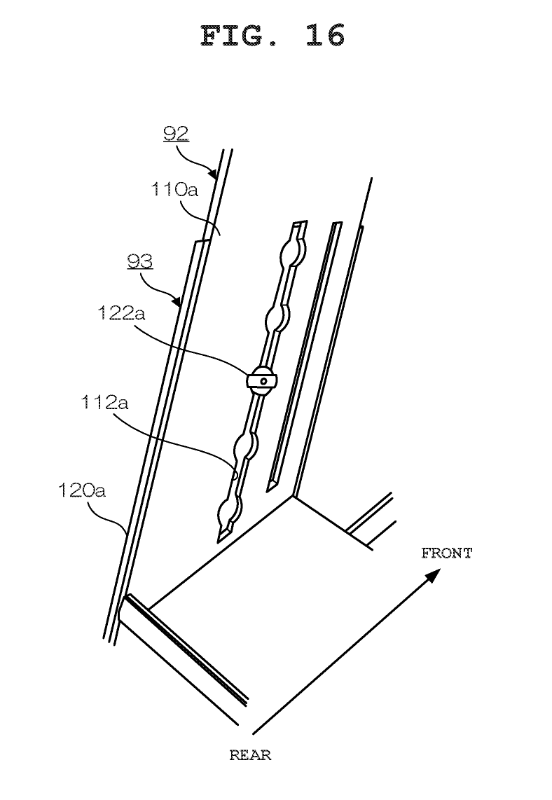

FIG. 16 is a perspective view for describing the structure of a lifting mechanism by the imaging apparatus stand 90. Note that, in FIG. 16, a structure related to only one of surfaces is shown. Accordingly, in the following descriptions, a structure related to the other surface is indicated by a symbol within parentheses. As described above, on the side plate 110a (110b) an adjustment hole 112a (112b) for adjusting and fixing the height of the leg section 92 is formed. The adjustment hole 112a (112b) has a shape where five circular holes formed at predetermined intervals in a vertical direction have been connected to one another in line by a long hole having a predetermined width, and the lifting button 122a (122b) of the leg section 93 is inserted from outside into the adjustment hole 112a (112b). By the lifting button 122a (122b) being locked in one of the circular holes in the adjustment hole 112a (112b), the leg section 92 can be fixed to the leg section 93 at a desired height (which is, in the example of the drawing, a height in one of five levels).

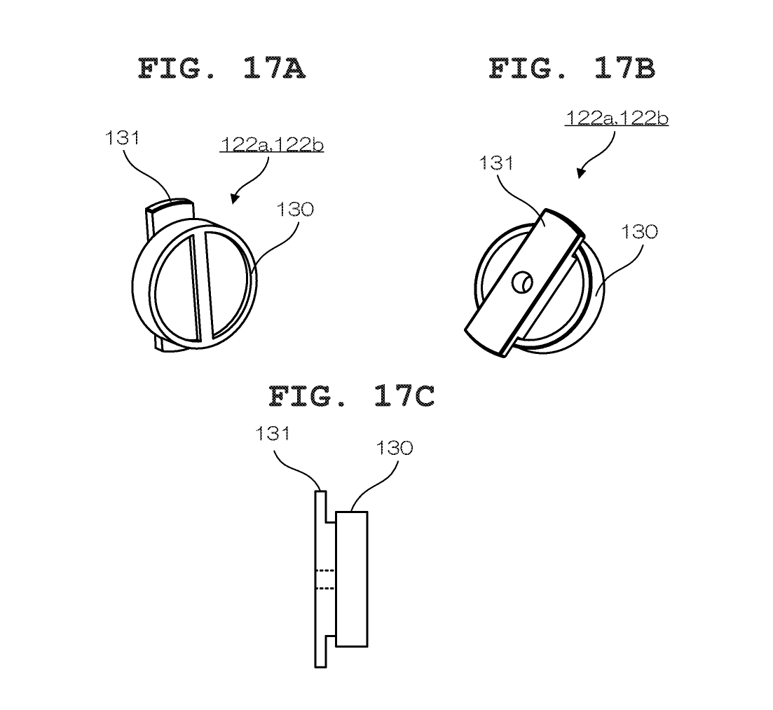

FIG. 17A and FIG. 17B are perspective views for describing the structure of the lifting button 122a (122b) of the imaging apparatus stand 90, and FIG. 17C is a side view of the lifting button 122a (122b). The lifting button 122a (122b) includes a circular operation section 130 positioned on the leg section 93 side and a locking section 131 positioned on the adjustment hole 112a (112b) side of the leg section 92. The locking section 131 has a length exceeding the diameter of the operation section 130 (the diameter of the circular holes in the adjustment hole 112a (112b) and has a width slightly smaller than the width of the long hole which connects the circular holes in the adjustment hole 112a (112b).

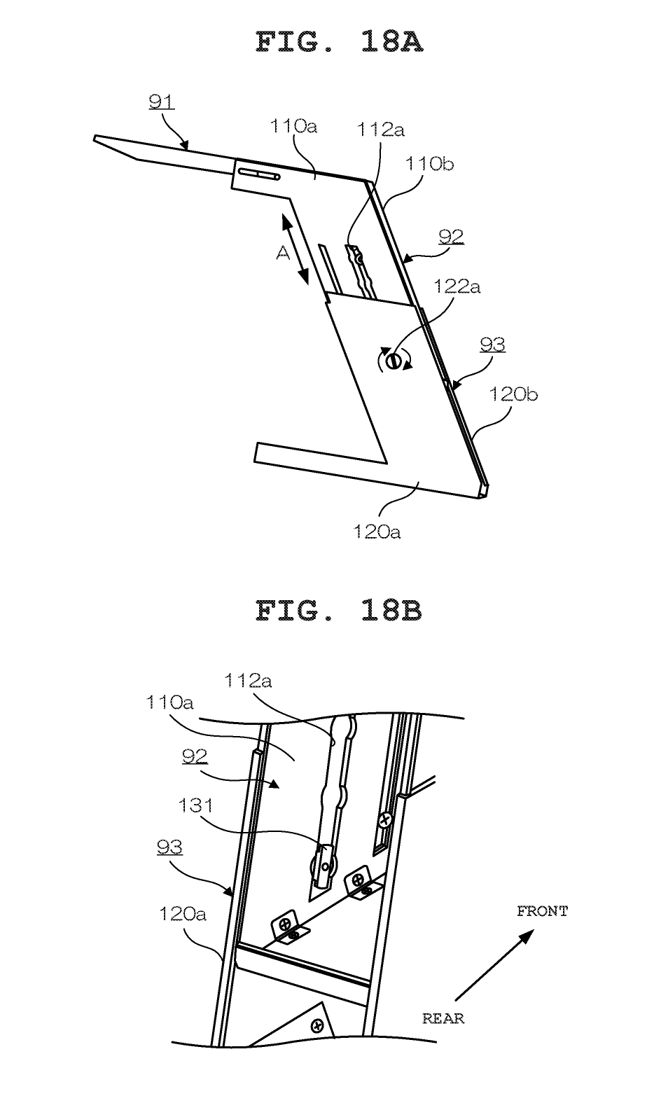

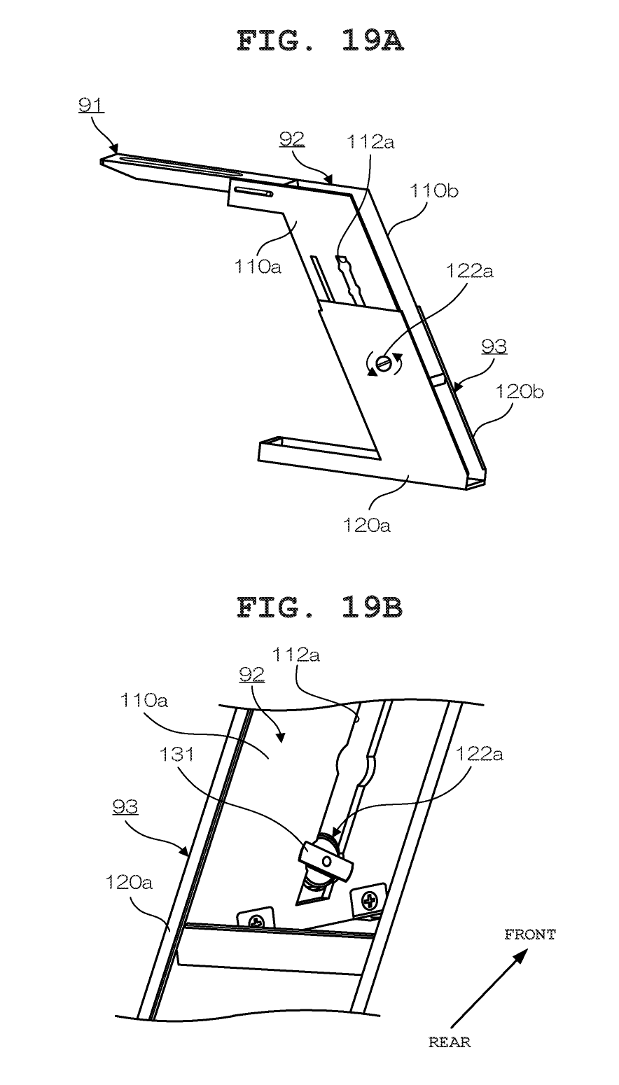

FIG. 18A and FIG. 18B are perspective views for describing a state occurring when the height of the leg section 92 to which the stage 91 has been fixed is adjusted in the imaging apparatus stand 90. FIG. 19A and FIG. 19B are perspective views for describing a state where the height of the leg section 92 to which the stage 91 has been fixed is fixed in the imaging apparatus stand 90.

When the leg section 92 to which the stage 91 has been fixed is to be lifted and lowered, the operation section 130 of the lifting button 122a (122b) is operated. More specifically, the operation section 130 of the lifting button 122a (122b) is rotated by 90° from outside the leg section 93 such that the locking section 131 of the lifting button 122a (122b) is angled to be along the long hole connecting the circular holes in the adjustment holes 112a (112b) as shown in FIG. 18A. When the locking section 131 of the lifting button 122a (122b) enters a state where it is along the adjustment hole 112a (112b), the locking section 131 enters a free state so that the leg section 92 can be moved (slid) upward or downward, as shown in FIG. 18B.

Then, the leg section 92 is moved (slid) upward or downward (see arrow A) so as to adjust the height (pull-out amount) of the leg section 92 such that one of the circular holes in the adjustment hole 112a (112b) corresponds to the position of the locking section 131 of the lifting button 122a (122b) and the stage 91 has a desired height, as shown in FIG. 18A.

After the height of the stage 91, i.e., the pull-out amount of the leg section 92 is determined, the operation section 130 of the lifting button 122a (122b) is rotated by 90° from outside the leg section 93, as shown in FIG. 19A. When the operation section 130 is rotated by 90°, the locking section 131 is rotated to be substantially horizontal to the circular holes in the adjustment hole 112a (112b), as shown in FIG. 19B. When the side plate 110a (110b) of the leg section 92 is inserted between the operation section 130 and the locking section 131, the up-and-down movement of the leg section 92 is restricted. As a result, the leg section 92 to which the stage 91 has been fixed is fixed at a desired height. By this structure, the height of the stage 91 can be easily adjusted in accordance with the viewing angle of the camera in the information processing terminal 80, the size of the book B or the like.

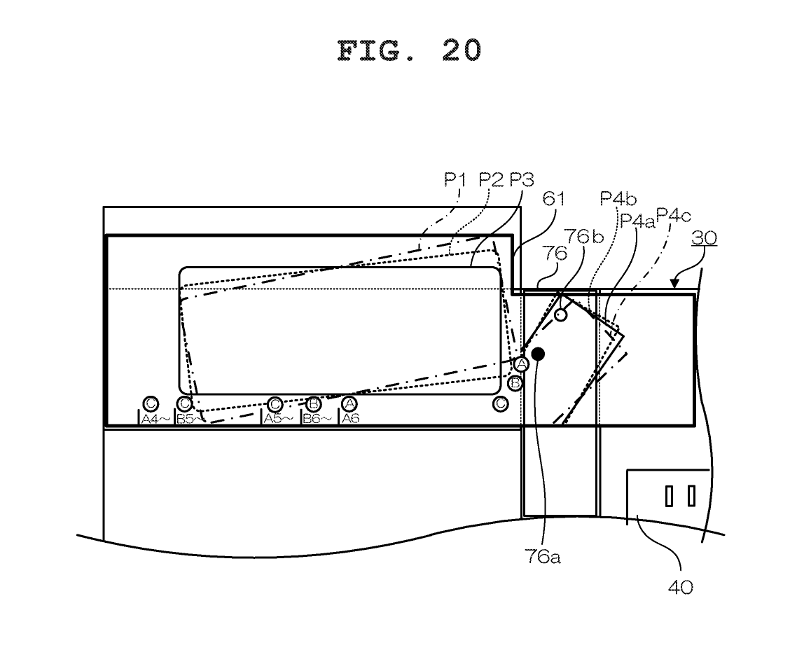

FIG. 20 is a top view showing the structure of a part of the casing 30 for describing another guide sheet 61 according to the present embodiment. Note that sections corresponding to those in FIG. 11 are provided with the same reference numerals, and descriptions thereof are omitted. On the guide sheet 61, installation position guides P4a, P4b and P4c each representing an installation position of the imaging apparatus stand 70 based on a book size are written in addition to markers (A6, B6˜, A5˜, B5˜ and A4˜), symbols (A, B and C) each representing an installation position of the page-turning main body section 10, and installation position guides P1, P2 and P3 each representing an installation position of the page-turning main body section 10, as with the above-described guide sheet 60. In the following descriptions, the installation position guides P4a, P4b and P4c are described in detail.

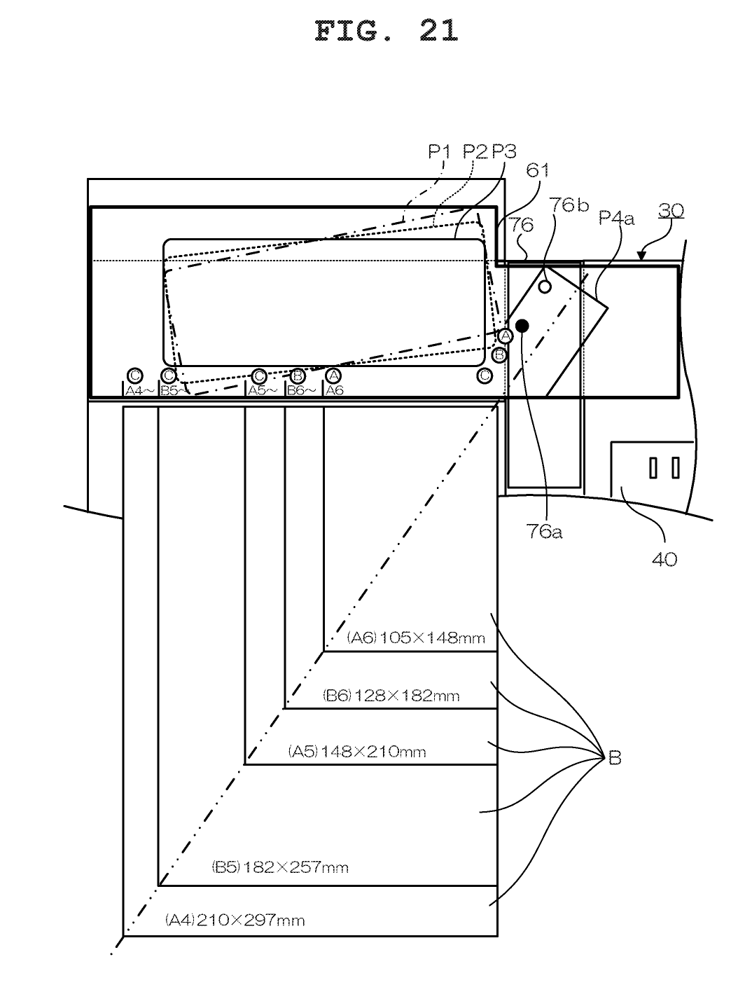

FIG. 21 is a top view for describing the installation position guide P4a on the guide sheet 61 The installation position guide P4a represents an installation position of the imaging apparatus stand 70 when a book B of a standard size (A4, B5, A5, B6 and A6) is placed on the holding table 20. In the cases of books B of standard sizes (A4, B5, A5, B6, and A6), their diagonal lines substantially coincide with one another. Accordingly, for cases of a book B of standard sizes (A4, B5, A5, B6 and A6), the installation position guide P4a is written at an angle at which the diagonal line of each of these book B and the center of the stage 71 in the imaging apparatus stand 70 substantially coincide with each other.

When a bock B of standard sizes (A4, B5, A5, B6 and A6) is placed on the holding table 20, the user rotates the stand installation plate 76 to which the imaging apparatus stand 70 has been fixed such that the stand installation plate 76 coincides with the installation position guide P4a written on the guide sheet 61. By the installation position of the imaging apparatus stand 70 being rotated to coincide with the installation position guide P4a, operations such as the position adjustment of the imaging apparatus stand 70 and the viewing angle adjustment of the camera in the information processing terminal 80 for setting the pages P of the book B of standard sizes (A4, B5, A5, B6 and A6) to be within the viewing angle of the camera in the information processing terminal 80 can be achieved with a minimal amount of effort.

Note that, in this state, the center of the opening section 101 formed along the longitudinal direction of the stage 91 and the diagonal line of the book B substantially correspond to each other. Accordingly, the user is only required to move the information processing terminal 80 along the longitudinal direction of the opening section 101 in the stage 91 so as to align the imaging means. That is, by merely moving the information processing terminal 80 along the longitudinal direction of the opening section 101 in the stage 91, the user can easily adjust the position of the camera in the information processing terminal 80.

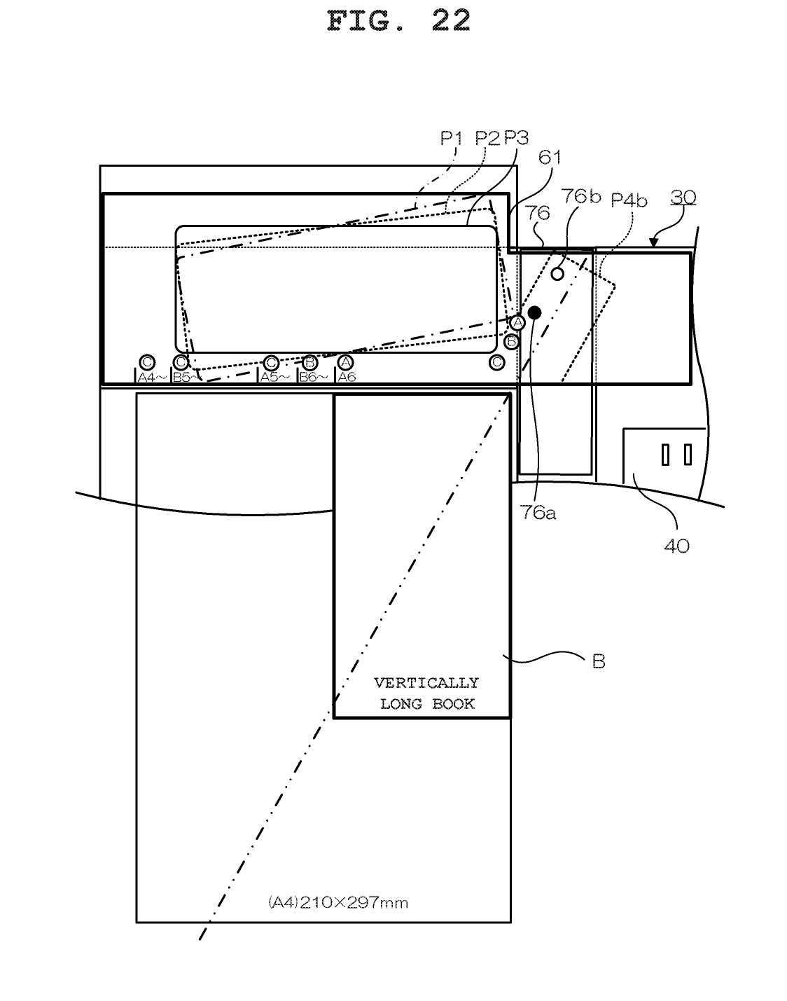

FIG. 22 is a top view for describing the installation position guide P4b on the guide sheet 61. The installation position guide P4b represents an installation position of the imaging apparatus stand 70 when a book B having an aspect ratio vertically longer than that of each standard size (in the drawing, only the A4 size is shown as an example) is placed on the holding table 20. In the case of a book B having an aspect ratio vertically longer than that of the standard size (A4 size), the book B is shifted from the diagonal line of the standard size (A4 size). Accordingly, for the case of a book B having an aspect ratio vertically longer than that of the standard size (A4 size), the installation position guide P4b is written at an angle at which the diagonal line of the book B having this size and the center of the stage 71 in the imaging apparatus stand 70 substantially coincide with each other.

When a book B having an aspect ratio vertically longer than that of the standard size (A4 size) is placed on the holding table 20, the user rotates the stand installation plate 76 to which the imaging apparatus stand 70 has been fixed such that the stand installation plate 76 coincides with the installation position guide P4b written on the guide sheet 61. By the installation position of the imaging apparatus stand 70 being rotated to coincide with the installation position guide P4b, operations such as the position adjustment of the imaging apparatus stand 70 and the viewing angle adjustment of the camera in the information processing terminal 80 for setting the pages P of the book B having an aspect ratio vertically longer than that of the standard size (A4 size) to be within the viewing angle of the camera in the information processing terminal 80 can be achieved with a minimal amount of effort. In this case as well, by merely moving the information processing terminal 80 along the longitudinal direction of the opening section 101 in the stage 91 as described above, the user can easily adjust the position of the camera in the information processing terminal 80.

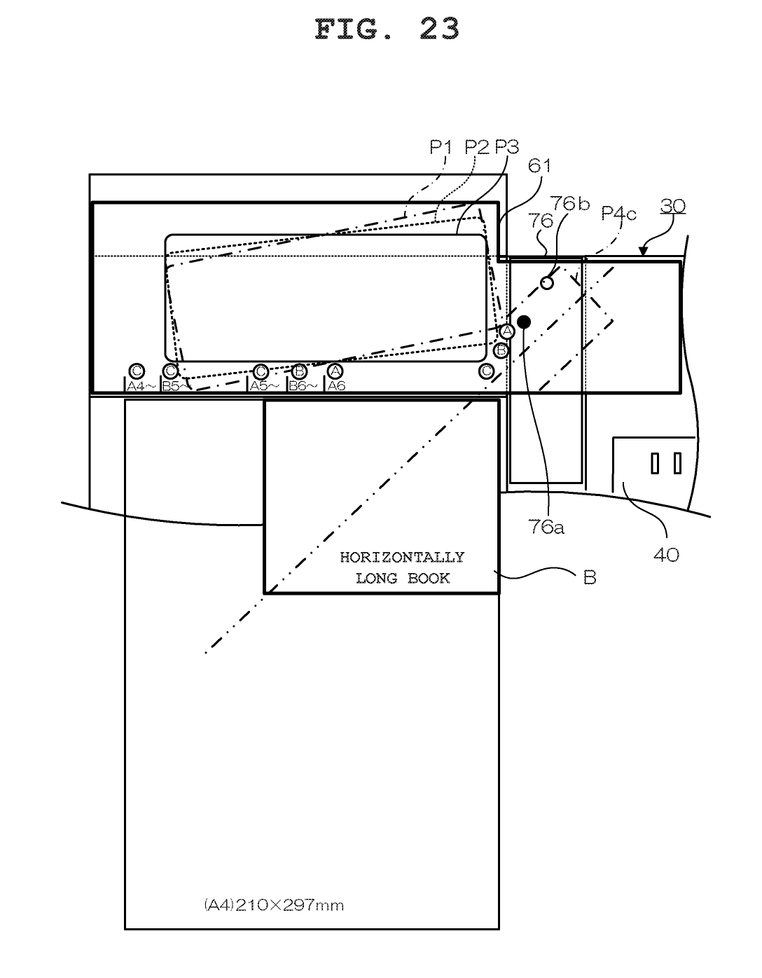

FIG. 23 is a top view for describing the installation position guide P4c on the guide sheet 61. The installation position guide P4c represents an installation position of the imaging apparatus stand 70 when a book B having an aspect ratio horizontally longer than that of each standard size (in the drawing, only the A4 size is shown as an example) is placed on the holding table 20. In the case of a book B having an aspect ratio horizontally longer than that of the standard size (A4 size), the book B is shifted from the diagonal line of the standard size (A4 size). Accordingly, for the case of a book B having an aspect ratio horizontally longer than that of the standard size (A4 size), the installation position guide P4c is written at an angle at which the diagonal line of the book B having this size and the center of the stage 71 in the imaging apparatus stand 70 substantially coincide with each other.

When a book B having an aspect ratio horizontally longer than that of the standard size (A4 size) is placed on the holding table 20, the user rotates the stand installation plate 76 to which the imaging apparatus stand 70 has been fixed such that the stand installation plate 76 coincides with the installation position guide P4c written on the guide sheet 61. By the installation position of the imaging apparatus stand 70 being rotated to coincide with the installation position guide P4c, operations such as the position adjustment of the imaging apparatus stand 70 and the viewing angle adjustment of the camera in the information processing terminal 80 for setting the pages P of the book B having an aspect ratio horizontally longer than that of the standard size (A4 size) to be within the viewing angle of the camera in the information processing terminal 80 can be achieved with a minimal amount of effort. In this case as well, by merely moving the information processing terminal 80 along the longitudinal direction of the opening section 101 in the stage 91 as described above, the user can easily adjust the position of the camera in the information processing terminal 80.

According to the above-described embodiment, the holding table 20 and the page-turning main body section 10 having the page-turning mechanism are accommodated in a substantially rectangular parallelepiped shape whose vertical and horizontal size is a size of a predetermined book, e.g., the A4 size by the casing 30 including the plurality of constituent surfaces 31 to 34. Accordingly, the page turner 1 can be compactly accommodated and easily stored in an ordinary cabinet, bookshelf or the like.

Also, according to the above-described embodiment, the holding table 20 is constituted by the main body section 23 including the holding plates 21a and 22a and the expansion unit 24 including the holding plates 21a and 22b so that it can be divided into the main body section 23 and the expansion unit 24. When the page turner 1 is to he accommodated, by removing the expansion unit 24, the vertical and horizontal size of the area occupied by the holding plates 21a and 22a and the page-turning main body section 10 become equal to the size of the predetermined book, e.g., the A4 size. Accordingly, the page turner 1 can be compactly accommodated and easily stored in an ordinary cabinet, bookshelf or the like.

Moreover, according to the above-described embodiment, the air blowing section 16 which assists page-turning operations by the page-turning mechanism is provided separately from the accommodation case 11 where the page-turning mechanism has been accommodated. Accordingly, the size (capacity) of the accommodation case 11 can be reduced, and the degree of freedom for the arrangement of the air blowing section 16 can be improved. As a result, the page-turning main body section 10 can be downsized. Therefore, the page turner 1 can be compactly accommodated and easily stored in an ordinary cabinet, bookshelf or the like.

Furthermore, according to the above-described embodiment, when the page turner 1 is to be accommodated by the casing 30, the air blowing section 16 is moved to a position where the air blowing section 16 and the accommodation case 11 are aligned and substantially flush with each other, so that the horizontal size of the area occupied by the air blowing section 16 and the accommodation case 11 become equal to the horizontal size of the predetermined book, e.g., the A4 horizontal size. Accordingly, the page turner 1 can be compactly accommodated and easily stored in an ordinary cabinet, bookshelf or the like.

Still further, according to the above-described embodiment, the main body unit 50 having the substantially rectangular parallelepiped shape by the casing 30 is inserted between the paired leg sections 72 constituting the imaging apparatus stand 70. Therefore, the accommodation of the imaging apparatus stand 70 itself is not required to be considered, and the substantially rectangular parallelepiped main body unit 50 can be supported by the leg sections 72 from both sides thereof.

Yet still further, according to the above-described embodiment, the casing 30 is also used as an installation sheet on which at least the holding table 20 and the page-turning main body section 10 are installed when the page turner 1 is used. Accordingly, at the time of use, the page turner 1 can be prepared only by the casing 30 being unfolded. Also, at the time of accommodation, the page turner 1 can be easily accommodated in a substantially rectangular parallelepiped shape only by the casing 30 being folded.

Yet still further, according to the above-described embodiment, the casing 30 includes the four constituent surfaces 31 to 34. The respective vertical and horizontal sizes of two constituent surfaces 31 and 33 among the four constituent surfaces 31 to 34 are each equal to the vertical and horizontal size of a predetermined book such as the A4 size, one constituent surface 32 among the four constituent surfaces 31 to 34 couples the two constituent surfaces 31 and 33 having the A4 size, another constituent surface 34 among the four constituent surfaces 31 to 34 is coupled to one constituent surface 31 of the two constituent surfaces 31 and 33 having the A4 size, and the four constituent surfaces 31 to 34 are held at a predetermined angle so as to form the substantially rectangular parallelepiped shape. Accordingly, the page turner 1 can be easily accommodated in the substantially rectangular parallelepiped shape only by the casing 30 being folded.

While the present invention has been described with reference to the preferred embodiments, it is intended that the invention be not limited by any of the details of the description therein but includes all the embodiments which fall within the scope of the appended claims.

What is claimed is:

1. An apparatus for turning pages of an opened book, comprising:
a holding table which holds the opened book by a pair of holding plates;
a main body section which holds a page of the opened book at a page-turning start point by a sticking section, and turns over the page toward a page-turning end point by the sticking section; and
a casing which is constituted by a plurality of constituent surfaces including a constituent surface where the holding table is fixed, and accommodates the holding table and the main body section in a rectangular parallelepiped shape.

2. The apparatus according to claim 1, wherein the holding table is structured to be dividable, and a vertical and horizontal size of an area occupied by the holding table after division and the main body section is equal to a vertical and horizontal size of the casing having the rectangular parallelepiped shape.

3. The apparatus according to claim 1, wherein the main body section comprises an accommodation case which is structured to accommodate a page-turning mechanism including the sticking section, and an air blowing section which is provided separately from the accommodation case and blows air onto the page being turned over.

4. The apparatus according to claim 3, wherein the air blowing section is moved to a position where the air blowing section and the accommodation case are aligned and flush with each other when accommodated by the casing, and a horizontal size that the air blowing section in a moved state and the accommodation case occupies is equal to a horizontal size of the casing having the rectangular parallelepiped shape.

5. The apparatus according to claim 1, further comprising:
a stand which includes a pair of leg sections and on which an information processing terminal having an imaging section for photographing each page of the book is placed,
wherein the holding table and the main body section accommodated in the rectangular parallelepiped shape by the casing are inserted between the pair of leg sections constituting the stand.

6. The apparatus according to claim 1, wherein the casing is unfolded when the apparatus is used, and used also as an installation sheet where at least the holding table and the main body section are installed.

7. The apparatus according to claim 1, wherein the casing is constituted by at least four constituent surfaces,
wherein vertical and horizontal sizes of two constituent surfaces among the four constituent surfaces are each equal to a vertical and horizontal size of the casing having the rectangular parallelepiped shape,
wherein one constituent surface among the four constituent surfaces couples the two constituent surfaces,
wherein another constituent surface among the four constituent surfaces is coupled to one of the two constituent surfaces, and
wherein the four constituent surfaces are held at a predetermined angle so as to form the rectangular parallelepiped shape.

8. The apparatus according to claim 1, wherein the casing accommodates the holding table and the main body section in a rectangular parallelepiped shape having a size equal to a vertical and horizontal size of a predetermined book.

9. An accommodation method for an apparatus for turning pages of an opened book, comprising:
accommodating a holding table which holds the opened book by a pair of holding plates and a main body section which holds a page of the opened book at a page-turning start point by a sticking section and turns over the page toward a page-turning end point by the sticking section, in a manner that the holding table and the main body section are accommodated in a rectangular parallelepiped shape by a casing constituted by a plurality of constituent surfaces including a constituent surface where the holding table is fixed

10. The accommodation method according to claim 9, wherein the holding table and the main body section accommodated in the rectangular parallelepiped shape by the casing are inserted between a pair of leg sections constituting a stand on which an information processing terminal for photographing each page of the book is placed.

11. The accommodation method according to claim 9, wherein the casing is unfolded when the apparatus for turning the pages of the book is used, and also used as an installation sheet where at least the holding table and the main body section are installed.

12. The accommodation method according to claim 9,
wherein the casing is constituted by at least four constituent surfaces,
wherein vertical and horizontal sizes of two constituent surfaces among the tour constituent surfaces are each equal to a vertical and horizontal size of the casing having the rectangular parallelepiped shape,
wherein one constituent surface among the four constituent surfaces couples the two constituent surfaces,
wherein another constituent surface among the four constituent surfaces is coupled to one of the two constituent surfaces, and
wherein the four constituent surfaces are held at a predetermined angle so as to form the rectangular parallelepiped shape.

13. The accommodation method according to claim 9, wherein the casing accommodates the holding table and the main body section in a rectangular parallelepiped shape having a size equal to a vertical and horizontal size of a predetermined book.
